(19) United States
(12) Patent Application Publication
(10) Pub. No.: US 2007/0159514 A1
(43) Pub. Date: Jul. 12, 2007

(54) Inkjet head and method of manufacturing inkjet head

(75) Inventors: Byung-ha Park, Suwon-si (KR); Nam-kyun Kim, Seongnam-si (KR); Young-ung Ha, Suwon-si (KR); Youn-shik Park, Seongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/528,391

(22) Filed: Sep. 28, 2006

(30) Foreign Application Priority Data
Jan. 10, 2006 (KR) 2006-2737

(51) Int. Cl. B41J 2/045

(52) U.S. Cl. 347/68

(57) ABSTRACT

An inkjet head including a substrate having a manifold supplying ink, a chamber formed of a photocurable epoxy resin, the chamber having a heat source and forming an ink chamber to temporarily storing the ink, and a nozzle plate formed on the chamber using a thermocurable epoxy resin and including a plurality of nozzles ejecting the ink, and a method of manufacturing the inkjet head.

### CROSS-REFERENCE TO RELATED APPLICATIONS

This application claims priority under 35 U.S.C. §119(a) from Korean Patent Application No. 10-2006-0002737, filed on Jan. 10, 2006, in the Korean Intellectual Property Office, the disclosure of which is incorporated herein in its entirety by reference.

### BACKGROUND OF THE INVENTION

1. Field of the Invention

The present general inventive concept relates to an inkjet head, and more particularly, to a bubble jet type inkjet head and a method of manufacturing the inkjet head.

2. Description of the Related Art

Inkjet printheads eject ink using an ejection mechanism employing an electro-thermal transducer or an electro-mechanical transducer. In a method of ejecting ink using an electro-thermal transducer (a bubble jet method), bubbles are generated in ink using a heat source, and the ink is ejected by an expansion of the bubbles. In a method of ejecting ink using an electro-mechanical transducer, a piezoelectric material is deformed to apply a pressure to ink, and the ink is ejected by the pressure.

FIG. 1 is a cross sectional view illustrating a conventional bubble jet type inkjet head 10.

Referring to FIG. 1, the inkjet head 10 includes a substrate 11 in which a manifold 12 is formed, a chamber layer 13 enclosing an ink chamber 16, and a nozzle plate 17 formed on the chamber layer 13. The manifold 12 supplies ink to the ink chamber 16, and the ink chamber 16 communicates with the manifold 12 to temporarily store the ink supplied from the manifold 12. The nozzle plate 17 includes a plurality of nozzles 18 to eject the ink from the ink chamber 16 to outside of the inkjet head 10.

A heat source 14 is formed in the ink chamber 16 for ejecting the ink therefrom, and a terminal 15 is formed outside of the ink chamber 16 to apply an electric signal to the heat source 14.

A method of manufacturing the inkjet head 10 of FIG. 1 is disclosed in U.S. Pat. No. 6,409,312. FIGS. 2A through 2D are cross-sectional views illustrating the method disclosed in U.S. Pat. No. 6,409,312.

Referring to FIG. 2A, the chamber layer 13 is formed on the substrate 11. A space for the ink chamber 16 is empty. The heat source 14 is formed on the substrate 11 inside the space for the ink chamber 16, and the terminal 15 is formed on the substrate 11 outside the chamber layer 13.

Referring to FIG. 2B, a positive photoresist 19 is filled in the space for the ink chamber 16 and outside the space for the ink chamber 16. This process is called a fill-up process. The positive photoresist 19 covering the chamber layer 13 has to be removed to a height equal to that of the chamber layer 13. Conventionally, the positive photoresist 19 is leveled as illustrated in FIG. 2C by chemical mechanical polishing (CMP).

Referring to FIG. 2D, a nozzle layer is formed on the chamber 13 and the positive photoresist 19, and then the positive photoresist 19 is patterned using an etch mask to form the nozzles 18.

However, the conventional method of manufacturing the inkjet head 10 using the fill-up process has at least the following disadvantages.

In the fill-up process, the photoresist 19 is not filled to a constant height in a length direction of the substrate 11. The height of the photoresist is low between sections of the chamber layer 13 above the space for the ink chamber 16, as illustrated in FIG. 2B. Particularly, in the case where the photoresist 19 has a portion lower than the chamber layer 13 as illustrated by a dash-point line in FIG. 2B, the lower portion of the photoresist 19 remains after the photoresist 19 is leveled by CMP. In this case, the forming of the nozzle plate 17 on the photoresist is affected.

Furthermore, when a plurality of inkjet heads 10 is simultaneously formed on a wafer, the photoresist 19 is not uniformly leveled over the wafer by CMP. Therefore, it is difficult to adjust a size of the photoresist 19 to a desired size. Consequently, it is difficult to form a flow channel having a desired thickness.

In addition, since it is difficult to form a uniform flow channel structure, cells of the inkjet head are not uniformly formed, and thus ink ejecting performance of the inkjet head is deteriorated.

### SUMMARY OF THE INVENTION

The present general inventive concept provides an inkjet head manufactured through a simple process without fill-up and CMP stages, and a method of manufacturing the inkjet head.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet head, including a substrate including a manifold to supply ink, a chamber formed of a photocurable epoxy resin, and having a heat source mounted thereon, the chamber forming an ink chamber to temporarily store the ink, and a nozzle plate formed of a thermocurable epoxy resin on the chamber and including a plurality of nozzles to eject the ink.

The foregoing and/or other aspects and utilities of the present general inventive concept may also be achieved by providing a method of manufacturing an inkjet head, the method including forming a heat source and an electrode on a substrate, forming a chamber layer on the substrate by coating the substrate with a photocurable epoxy resin, forming a nozzle layer on the chamber layer by coating the chamber layer with a thermocurable epoxy resin, forming a plurality of nozzles in the nozzle layer, forming a manifold in the substrate, and forming an ink chamber in the chamber layer by removing portions of the chamber layer between chamber walls.

The foregoing and/or other aspects and utilities of the present general inventive concept may also be achieved by providing a printhead, including a substrate including an electro-thermal transducer, a chamber layer having a predetermined height formed on the substrate and including an ink chamber formed around the electro-thermal transducer to contain ink, and a nozzle layer having a predetermined height formed on the chamber layer and including a nozzle to eject the ink from the ink chamber, in which the chamber layer comprises a first curable epoxy resin, the nozzle layer comprises a second curable epoxy resin, and the first and second curable epoxy resins are curable by different mechanisms.

The nozzle layer may include a thermocurable epoxy resin. The chamber layer may include a photocurable epoxy resin. The printhead may further include a manifold formed in the substrate to supply the ink to the ink chamber.

The foregoing and/or other aspects and utilities of the present general inventive concept may also be achieved by providing a method of manufacturing a printhead, the method including forming a chamber layer having a predetermined height on a substrate, the chamber layer including an ink chamber to contain ink and the substrate including an electro-thermal transducer to heat the ink contained in the ink chamber, and forming a nozzle layer having a predetermined height on the chamber layer, the nozzle layer including a nozzle to eject the ink from the ink chamber, and the chamber layer comprises a first curable epoxy resin, the nozzle layer comprises a second curable epoxy resin, and the first and second curable epoxy resins are curable by different mechanisms.

The forming of the chamber layer may include coating the chamber layer having the predetermined height on the substrate, and hardening a portion of the chamber layer corresponding to walls defining the ink chamber. The coating of the chamber layer may include coating a photocurable epoxy resin to a predetermined height on the substrate. The hardening of the portion of the chamber layer may include covering the chamber layer with a patterned negative photoresist, and irradiating light to the chamber layer covered with the patterned negative photoresist to harden portions of the chamber layer that are exposed to the light through the patterned negative photoresist.

The forming of the nozzle layer may include coating the nozzle layer having the predetermined height on the chamber layer having the hardened portion, removing an unhardened portion of the chamber layer to form the ink chamber, and hardening the nozzle layer. The coating of the nozzle layer may include coating a thermocurable epoxy resin to a predetermined height on the chamber layer having the hardened portion. The hardening of the nozzle layer may include heating the nozzle layer for a predetermined period of time at a predetermined temperature.

The method may further include covering the hardened nozzle layer with a patterned positive photoresist, and irradiating light to the nozzle layer covered with the patterned positive photoresist and removing portions of the nozzle layer that are exposed to the light through the patterned positive photoresist to form the nozzle. The method may further include forming a manifold in the substrate to supply the ink to the ink chamber.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross sectional view illustrating a conventional bubble jet type inkjet head;

FIGS. 2A through 2D are cross sectional views illustrating a conventional method of manufacturing the inkjet head of FIG. 1; and

FIGS. 3 through 11 are cross sectional views illustrating a method of manufacturing an inkjet head according to an embodiment of the present general inventive concept.

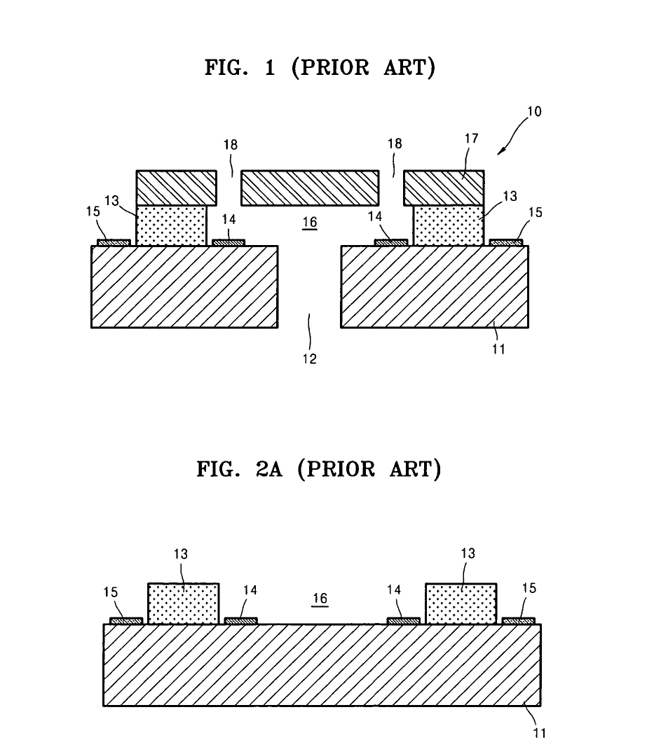

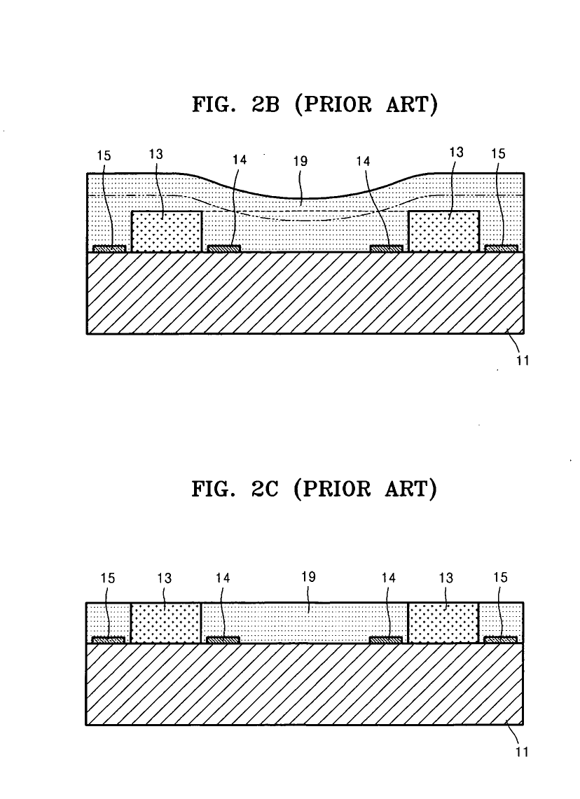

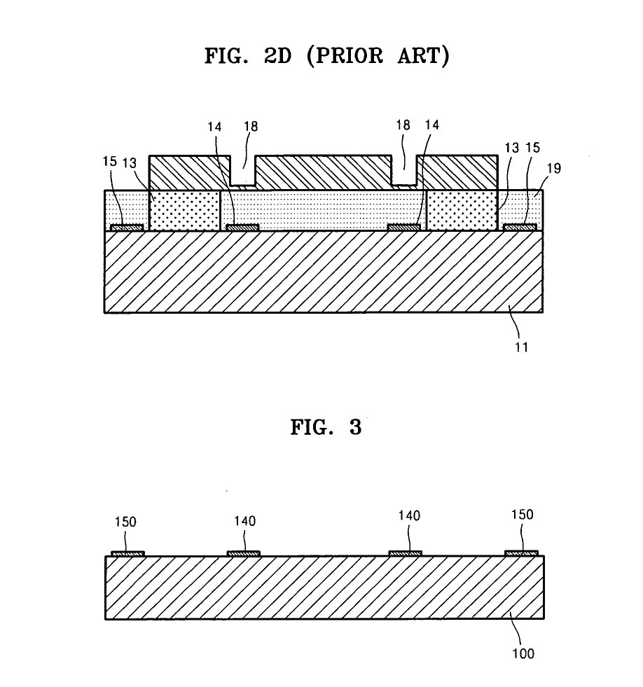

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIGS. 3 through 11 are cross sectional views illustrating a method of manufacturing an inkjet head according to an embodiment of the present general inventive concept.

To form a chamber layer and a nozzle layer in a conventional method of manufacturing an inkjet head, the chamber layer is formed on a substrate, and a sacrificial layer is filled in an empty space (corresponding to an ink chamber) of the chamber layer. Then, the nozzle layer is formed on the chamber layer, and the sacrificial layer is removed. However, according to embodiments of the present general inventive concept, a chamber layer is formed on a substrate, and a portion of the chamber layer corresponding to walls defining the ink chamber is hardened. Then, a nozzle layer is formed on the chamber layer, and the chamber layer is removed except for the hardened portion thereof to form the ink chamber. Therefore, according to embodiments of the present general inventive concept, an inkjet head can be manufactured more precisely and simply without using conventional fill-up and CMP processes.

Referring to FIG. 3, a plurality of heat sources 140 and corresponding terminals 150 are formed on a substrate 100. Methods of forming the heat sources 140 and the terminals 150 are known. Thus, forming of the heat sources 140 and the terminals 150 will not be described in detail.

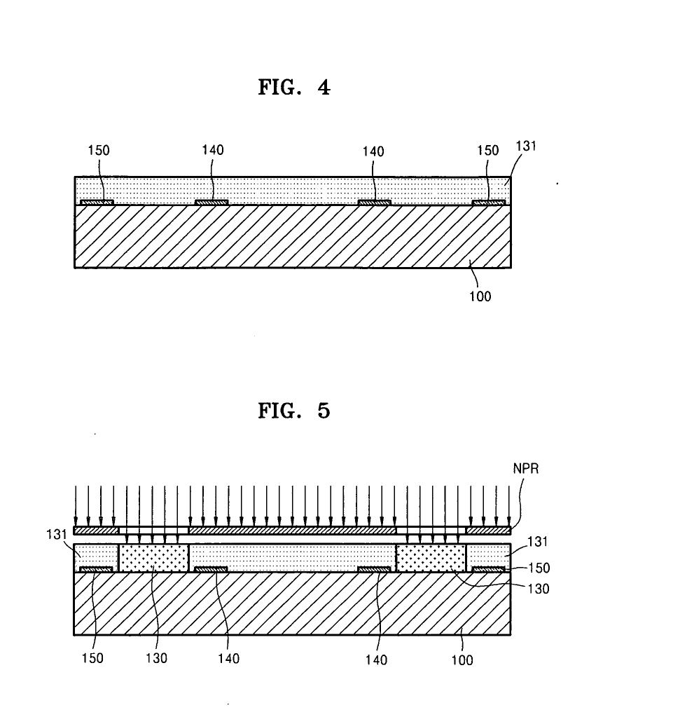

Referring to FIG. 4, a chamber layer 131 having a predetermined height is formed on the substrate 100 in an area where the heat sources 140 and the terminals 150 are formed. The chamber layer 131 may be formed by coating the substrate 100 with a photocurable epoxy resin.

Referring to FIG. 5, the chamber layer 131 is covered with a negative photoresist NPR, and light is irradiated to the chamber layer 131 to pattern a plurality of chamber walls 130. Portions of the chamber layer 131 exposed to the light will be formed into the chamber walls 130, and other portions not exposed to the light will be removed by etching.

Since the photocurable epoxy resin used to form the chamber layer 131 is hardened when exposed to light, portions of the chamber layer 131 to form the chamber walls 130 are exposed to the light, and the other portions are not exposed to the light due to the negative photoresist NPR. Therefore, only the portions of the chamber layer 131 to form the chamber walls 130 are hardened by the light.

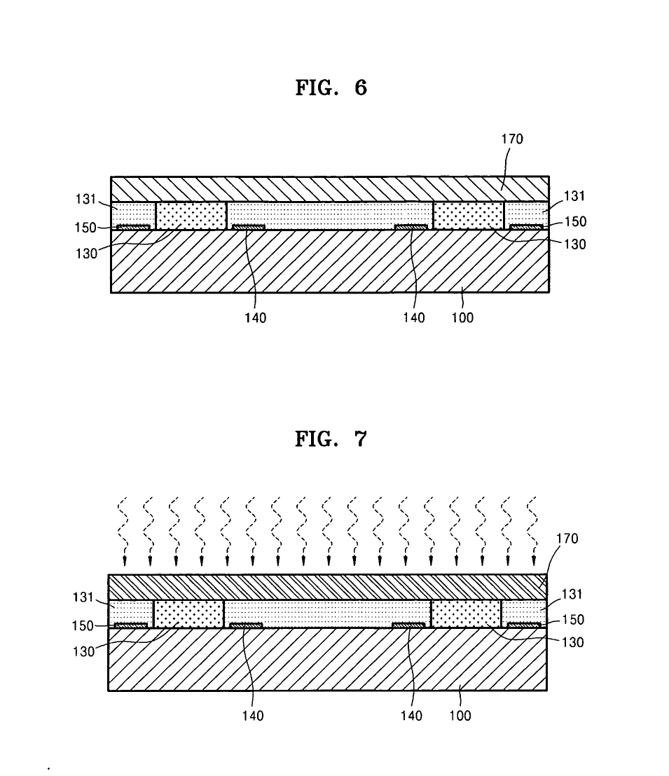

Referring to FIG. 6, after the chamber layer 131 is partially hardened (i.e., after the portions of the chamber layer 131 corresponding to the chamber walls 130 are hardened), a nozzle layer 170 is formed on the chamber layer 131 to a predetermined height. The nozzle layer 170 may be formed by coating the chamber layer 131 with a thermocurable epoxy resin.

The thermocurable epoxy resin may be prepared as follows. 10 ml of CP-66 (a thermo-initiator made by Asahi Denka Korea Chemical Co.) and 50 ml of xylene (a product made by Samchun Chemical Co.) are mixed, and 90 g of EHPH-3150 epoxy resin (a product of Daicel Chemical Co.) is added to the mixture. Then, the mixture solution of CP-66, xylene, and EHPH-3150 is agitated using an impeller for about 24 hours.

Referring to FIG. 7, the nozzle layer 170 is hardened at a temperature of about 140° C. for 20 minutes. Since the thermocurable epoxy resin used to form the nozzle layer 170 in this embodiment is hardened by heat, heat is applied to the nozzle layer 170 to harden the nozzle layer 170.

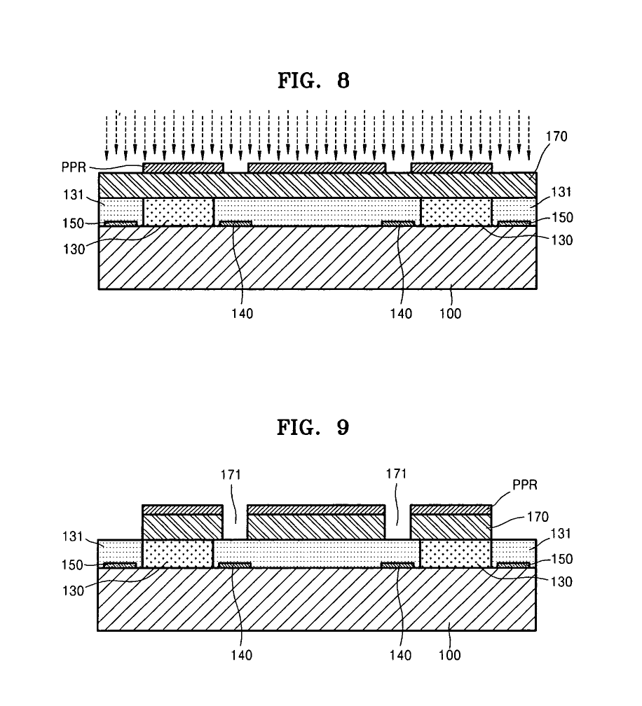

Referring to FIG. 8, the hardened nozzle layer 170 is covered with a positive photoresist PPR having a pattern to form a plurality of nozzles 171, and light is irradiated to the nozzle layer 170. Portions of the nozzle layer 170 exposed to the light will be removed by etching, and other portions not exposed to the light will not removed by etching.

According to this embodiment, the nozzle layer 170 is formed of the thermocurable epoxy resin and hardened using the heat. In this case, light passes through the hardened nozzle layer 170, but does not pass through the chamber layer 131 formed under the nozzle layer 170, such that only the nozzle layer 170 can be partially removed by etching. On the other hand, when the nozzle layer 170 is formed of a photocurable epoxy resin and light is irradiated to the nozzle layer 170, the light passes through both the nozzle layer 170 and the chamber layer 131. In this case, it is difficult to obtain a desired structure.

Referring to FIG. 9, after light is irradiated to the nozzle layer 170 covered with the positive photoresist PPR, portions of the nozzle layer 170 exposed to the light are removed by, for example, reactive ion etching (RIE) using O₂CF₄ plasma, in order to form a plurality of nozzles 171.

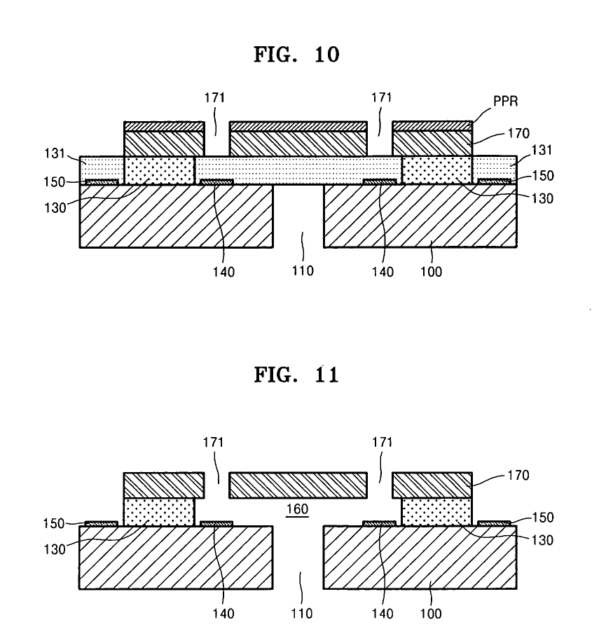

Referring to FIG. 10, an ink-supplying manifold 110 is formed in the substrate 100. Methods of forming the manifold 110 are known. Thus, the forming of the manifold 110 will not be described in detail.

Referring to FIG. 11, the chamber layer 131 is removed except for the chamber walls 130 hardened by exposure to the light to form an ink chamber 160 to temporarily store ink. As a result, the heat sources 140 and the terminals 150 are exposed to the light.

As described above, the method of manufacturing the inkjet head according to embodiments of the present general inventive concept has at least the following advantages.

Since conventional fill-up and CMP processes are not used, the method is simple and a productivity thereof is high.

Furthermore, high resolution nozzles and ink flow channels can be precisely formed and cell uniformity can be improved.

In addition, since ink flow channels of the inkjet head can be uniformly formed and dimensions of the inkjet head can be controlled to a desired degree, an ink ejecting performance of the inkjet head can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet head, comprising:
a substrate including a manifold to supply ink;
a chamber formed of a photocurable epoxy resin, and having a heat source mounted thereon, the chamber forming an ink chamber to temporarily store the ink; and
a nozzle plate formed of a thermocurable epoxy resin on the chamber and including a plurality of nozzles to eject the ink.

2. The inkjet head of claim 1, wherein the thermocurable epoxy resin comprises:
a CP-66 thermo-initiator.

3. A method of manufacturing an inkjet head, the method comprising:
forming a heat source and an electrode on a substrate;
forming a chamber layer on the substrate by coating the substrate with a photocurable epoxy resin;
forming a nozzle layer on the chamber layer by coating the chamber layer with a thermocurable epoxy resin;
forming a plurality of nozzles in the nozzle layer;
forming a manifold in the substrate; and
forming an ink chamber in the chamber layer by removing portions of the chamber layer between chamber walls.

4. The method of claim 3, further comprising:
after the forming of the chamber layer, hardening a portion of the chamber layer corresponding to the chamber walls by partially exposing the chamber layer to light using a negative photoresist.

5. The method of claim 3, further comprising:
after the forming of the nozzle layer, hardening the nozzle layer by applying heat to the nozzle layer.

6. The method of claim 5, wherein the hardening of the nozzle layer comprises:
hardening the nozzle layer at a temperature of about 140° C. for about 20 minutes.

7. The method of claim 3, wherein the forming of the plurality of nozzles comprises:
partially exposing the nozzle layer to light using a positive photoresist; and
etching portions of the nozzle layer exposed to the light to remove the portions of the nozzle layer exposed to the light.

8. The method of claim 7, wherein the etching comprises:
reactive ion etching the portions of the nozzle layer exposed to the light using O₂CF₄ plasma.

9. The method of claim 3, wherein the thermocurable epoxy resin used to form the nozzle layer comprises:
a CP-66 thermo-initiator.

10. A printhead, comprising:
a substrate including an electro-thermal transducer;
a chamber layer having a predetermined height formed on the substrate and including an ink chamber formed around the electro-thermal transducer to contain ink; and
a nozzle layer having a predetermined height formed on the chamber layer and including a nozzle to eject the ink from the ink chamber,
wherein the chamber layer comprises a first curable epoxy resin, the nozzle layer comprises a second curable epoxy resin, and the first and second curable epoxy resins are curable by different mechanisms.

11. The printhead of claim 10, wherein the nozzle layer comprises a thermocurable epoxy resin.

12. The printhead of claim 11, wherein the chamber layer comprises a photocurable epoxy resin.

13. The printhead of claim 10, further comprising:
a manifold formed in the substrate to supply the ink to the ink chamber.

14. A method of manufacturing a printhead, the method comprising:
forming a chamber layer having a predetermined height on a substrate, the chamber layer including an ink chamber to contain ink and the substrate including an electro-thermal transducer to heat the ink contained in the ink chamber; and
forming a nozzle layer having a predetermined height on the chamber layer, the nozzle layer including a nozzle to eject the ink from the ink chamber, wherein the chamber layer comprises a first curable epoxy resin, the nozzle layer comprises a second curable epoxy resin, and the first and second curable epoxy resins are curable by different mechanisms.

15. The method of claim 14, wherein the forming of the chamber layer comprises:
coating the chamber layer having the predetermined height on the substrate; and
hardening a portion of the chamber layer corresponding to walls defining the ink chamber.

16. The method of claim 15, wherein the coating of the chamber layer comprises:
coating a photocurable epoxy resin to a predetermined height on the substrate.

17. The method of claim 15, wherein the hardening of the portion of the chamber layer comprises:
covering the chamber layer with a patterned negative photoresist; and
irradiating light to the chamber layer covered with the patterned negative photoresist to harden portions of the chamber layer that are exposed to the light through the patterned negative photoresist.

18. The method of claim 14, wherein the forming of the nozzle layer comprises:
coating the nozzle layer having the predetermined height on the chamber layer having the hardened portion;
removing an unhardened portion of the chamber layer to form the ink chamber; and
hardening the nozzle layer.

19. The method of claim 18, wherein the coating of the nozzle layer comprises:
coating a thermocurable epoxy resin to a predetermined height on the chamber layer having the hardened portion.

20. The method of claim 18, wherein the hardening of the nozzle layer comprises:
heating the nozzle layer for a predetermined period of time at a predetermined temperature.

21. The method of claim 18, further comprising:
covering the hardened nozzle layer with a patterned positive photoresist; and
irradiating light to the nozzle layer covered with the patterned positive photoresist and removing portions of the nozzle layer that are exposed to the light through the patterned positive photoresist to form the nozzle.

22. The method of claim 14, further comprising:
forming a manifold in the substrate to supply the ink to the ink chamber.
